(19) United States
(12) Patent Application Publication
(10) Pub. No.: US 2017/0229712 A1
(43) Pub. Date: Aug. 10, 2017

(54) Superhydrophobic, Nanostructured Protective Layer for Rechargeable Lithium Battery Cells Having a Metal Lithium Anode

(71) Applicant: Robert Bosch GmbH, Stuttgart (DE)

(72) Inventors: Thomas Wöhrle, München (DE); Martin Tenzer, Nuertingen (DE)

(21) Appl. No.: 15/501,342

(22) PCT Filed: Jul. 30, 2015
(86) PCT No.: PCT/EP2015/067456

§ 371 Date: Feb. 2, 2017

(30) Foreign Application Priority Data
Aug. 4, 2014 (DE) 10 2014 215 268.2

(51) Int. Cl. H01M 4/62; H01M 2/16; H01M 4/04; H01M 10/0525; H01M 4/38

(52) U.S. Cl. CPC H01M 4/628; H01M 10/0525; H01M 4/382; H01M 4/0409; H01M 4/0419; H01M 4/0426; H01M 4/0428; H01M 2/1673

(57) ABSTRACT

A layer combination for an electrode can be used in rechargeable electrochemical cells. The rechargeable electrochemical cells are in the form of lithium batteries, e.g. a lithium-sulfur battery or a lithium-oxygen battery. The layer combination includes at least one superhydrophobic, nanostructured protective layer which repels polar substances.

### PRIOR ART

The invention relates to a layer composite for an electrode of a rechargeable electrochemical element, production processes therefor and the use thereof.

US 2005/0053834 A1 discloses an electrode for a lithium battery, which electrode is made up of particles. The individual particles are coded in order to provide them with a hydrophobic surface. Polymers and polymer mixtures, for example EPDM and PVDF, are proposed as hydrophobic coatings. Lithium salts can be added to the polymer in order to improve the lithium ion conductivity. Coating with the polymer can be effected by dissolving the polymer in a solvent and spraying it onto the particles.

WO 2012/111116 A1 relates to providing the surface of a positive electrode with a hydrophobic film.

WO 2010/027337 A1 discloses electrode materials for use in metal-air batteries. The electrode comprises a layer of a nanostructured, hydrophobic material, for example TiO₂, or of a ceramic material. Depending on the embodiment, the layer can be porous and comprise additional metallic nanostructures. In a further embodiment, the proposed electrode comprises an additional layer of a hydrophilic material.

WO 2004/088769 A2 discloses a lithium battery whose electrodes are provided with a coating in order to adapt their surface tension. The coating can, for example, be produced by means of a chemical reaction on the electrode surface or be applied as a solution in a solvent to the electrode. The use of polymers, e.g. polyethylene, is also possible. The electrode can further comprise nanostructures such as carbon nanotubes.

US 2003/0180608 A1 discloses a battery in which lithium metal is used as negative electrode. It is also possible to use a lithium alloy as negative electrode. Amorphous metallic lithium or amorphous lithium is coated on each surface with a layer of material having hydrophobic properties. The hydrophobic layer of material comprises at least one material selected from the group consisting of hydrocarbons and esters. Carbon in the hydrocarbon compounds or esters can be partly substituted by a silicon atom, or hydrogen atoms in the hydrophobic material can be partly or entirely replaced by fluorine atoms. The negative electrode can be coated with the hydrophobic material by dipping the negative electrode into a solution containing the hydrophobic material, or by sputtering or by vapor deposition processes.

US 2002/0086213 A1 discloses a lithium battery cell and a process for producing this. Metallic lithium or one of its alloys is used as active anode material. The anode additionally comprises a layer of hydrophobic material comprising at least one form of a hydrocarbon or ester, with carbon being able to be partly replaced by silicon or hydrogen being able to be partly or entirely replaced by fluorine or metallic fluoride materials.

In various types of lithium batteries, in particular post lithium ion batteries, for example Li-sulfur (Li—S) or Li-air batteries, a metallic lithium anode is used as anode. In addition, the use of metallic lithium anodes together with all other cathode materials, e.g. transition metal oxides such as lithium cobalt oxide, LiCoO₂, or the like, is also possible in principle, which gives this development direction an extremely great potential for providing high specific energies. However, the metallic lithium anode (without protection) has the disadvantage that parasitic reactions with the liquid electrolyte or materials present therein take place on it, for example with polysulfides in the case of an Li—S battery cell. Both electrolyte and the lithium itself are irreversibly consumed thereby.

In order to prevent this, a mechanically, chemically and electrochemically active protection layer on the metallic lithium anode, which prevents direct contact between metallic lithium and liquid electrolyte and at the same time has a sufficiently high lithium ion conductivity, is necessary. Such a protective layer functions perfectly only for so long as it has no defects in the form of cracks, holes, etc. during operation and the storage time during storage. As soon as such a defect has been formed, lithium preferably deposits there and reacts with liquid electrolyte, since the increased resistance provided by the protective layer is not present there. In this way, the defects themselves become enlarged to an increasing degree as soon as they have been formed. Thus, such protective layers can only function when it is ensured that mechanical and structural defects can be reliably avoided in the long term.

Such protective layers are always located between the anode and a cathode in a cell. In principle, they can have been applied directly to the anode, directly to the cathode or in between with further layers between the protective layer and the electrodes.

### DISCLOSURE OF THE INVENTION

The invention proposes a layer composite for an electrode of a rechargeable electrochemical element, which is, in particular, a lithium battery, wherein the layer composite comprises at least one superhydrophobic, nanostructured protective layer which repels polar substances. Polar substances are repelled by the at least one superhydrophobic, nanostructured protective layer and are thus kept in the second electrode or, depending on the arrangement, in the pores of a separator. These components are virtually completely kept away from the surface of a lithium anode.

In an advantageous embodiment of the layer composite proposed according to the invention, the superhydrophobic, nanostructured protective layer is made of nanostructured polypropylene (PP) or further polyolefins. Possible materials also include nanostructured polyethylene (PE) or nanostructured PE-PP copolymers. As an alternative, the superhydrophobic, nanostructured protective layer within the layer composite can also be made of nanostructured silicon or of a polymer.

The layer composite proposed according to the invention is, in a possible embodiment, of such a nature that the superhydrophobic, nanostructured protective layer within the layer composite has been applied directly to a lithium layer or to a second electrode. As an alternative or in addition, it is also possible to conceive of a layer composite in which the superhydrophobic, nanostructured protective layer within the layer composite is covered by at least one second polymer layer and/or at least one second ceramic layer.

The layer composite proposed according to the invention can also be configured in such a way that the superhydrophobic, nanostructured protective layer present therein has been applied to a lithium layer with intermediate insertion of a second polymer layer or a second ceramic layer.

In addition, it is also possible for the layer composite to be configured so that it has the superhydrophobic, nanostructured protective layer and at least one separator layer between a lithium layer and a second electrode, in particular sulfur electrode. The separator layers are advantageously polymer layers.

In addition, the present invention provides a process for producing such a layer composite, where a superhydrophobic, nanostructured protective layer is applied to a support substrate in one process step. The superhydrophobic, nanostructured protective layer can be applied to the support substrate by coating by means of a spray mist via a spray head with subsequent drying during which crosslinking or polymerization occurs. An alternative possibility is to apply the superhydrophobic, nanostructured protective layer by coating by means of application by doctor blade of a thin layer, which is followed by drying.

Furthermore, application of the superhydrophobic, nanostructured protective layer can be effected by vapor deposition or vacuum vapor deposition with subsequent crosslinking or polymerization.

When the superhydrophobic, nanostructured protective layer of nanostructured silicon is applied to a support substrate, it is possible to apply the superhydrophobic, nanostructured layer to the support substrate by sputtering, by aerosol (aerosol deposition method, ADM) or by plasma induced or plasma enhanced chemical deposition of material (plasma enhanced chemical vapor deposition, PECVD).

The layer composite as claimed according to the present invention can be used advantageously in lithium batteries, in particular lithium-sulfur battery systems (Li—S) or lithium-oxygen battery systems (Li—O), which are used as traction battery in hybrid vehicles (HEV), plug-in hybrid vehicles (PHEV) and electric vehicles (EV). In addition, the layer composite proposed according to the invention can be used as per the above-aligned variants in electric vehicles, garden tools, computers, notebooks, PDAs (personal digital assistants), smartphones or cell telephones.

### Advantages of the Invention

The layer composite proposed according to the invention allows, in an advantageous way, the cycling stability, the life and also the safety of a lithium battery to be increased significantly. This is due to the fact that contact between lithium and liquid electrolytes or species present therein, e.g. polysulfides, is ideally completely prevented or significantly reduced when the layer composite proposed according to the invention is employed. As a result of the repulsion of polar substances due to their hydrophobic character, polar components of the electrolyte and polar species dissolved therein are kept away from the surface of the lithium anode. A prominent feature of the superhydrophobic, nanostructured protective layer is the fact that, owing to its superhydrophobic character, it displays its repellant properties for polar components very well even when it has relatively small defects. This property distinguishes the superhydrophobic, nanostructured protective layer from other protective layers, since the latter generally fail as soon as relatively small defects have formed. Lithium deposits preferentially on these. The superhydrophobic, nanostructured layers are also very thin and, as passive material, do not significantly reduce the energy density of a lithium battery cell.

The superhydrophobic, nanostructured protective layers do not necessarily have to be ionically conductive to perform their function of repelling polar components present in electrolytes or in further materials present therein. For this purpose, the superhydrophobic, nanostructured protective layers are present in conjunction with other ceramic or polymeric layers within the layer composite. The ceramic and/or polymeric layers of the layer composite assume the task of lithium ion conduction. Ion conduction through the superhydrophobic, nanostructured protective layer occurs through holes in the layer, into which the respective other layers can then penetrate during the production process for the layer composite, when the protective layer itself is not ionically conductive.

In the present context, a superhydrophobic, nanostructured protective layer is a layer of this type for which the measure of hydrophobicity, i.e. the repulsion of polar materials, is a contact angle. Superhydrophobic nanostructured protective layers in the present context have a contact angle of >160°.

The use of a metallic lithium anode is associated with a series of advantages: thus, the specific energy and the energy density of a battery cell can be considerably increased by use of a metallic lithium anode. Furthermore, the production process for the cell is considerably simplified since a lithium foil can be purchased in finished, prepared and prefabricated form and costly apparatuses such as mixers, coaters, calenders, vacuum dryers or roller cutters for manufacturing the electrode, which are otherwise required for the production thereof, are unnecessary. The superhydrophobic, nanostructured protective layer can easily be produced by methods known to those skilled in the art, for example by spray coating or another coating process. Furthermore, rechargeable lithium battery cells can be used in a manner similar to primary lithium batteries in a dry room which is generally present on the premises of battery cell manufacturers.

### BRIEF DESCRIPTION OF THE DRAWINGS

The invention is illustrated in detail below with the aid of the drawings:

In the drawings:

FIG. 1 schematically shows various contact angles of water droplets which these have in relation to a hydrophilic, a hydrophobic and a superhydrophobic support substrate,

FIG. 2 shows a first variant of a layer composite containing a superhydrophobic, nanostructured protective layer,

FIG. 3 shows a further, second variant of the layer composite,

FIG. 4 shows a further, third variant of the layer composite,

FIG. 5 shows a fourth variant of the layer composite containing the superhydrophobic, nanostructured protective layer,

FIG. 6 schematically shows a production process for the superhydrophobic, nanostructured protective layer,

FIG. 7 shows a further, fifth layer composite comprising a second electrode and a first electrode and

FIG. 8 shows a further variant of a layer composite having a superhydrophobic, nanostructured protective layer embedded between two separator layers between a second electrode and a first electrode.

In the figures, identical or similar components are denoted by the same reference numerals. Repeated description of these components will be omitted in individual cases.

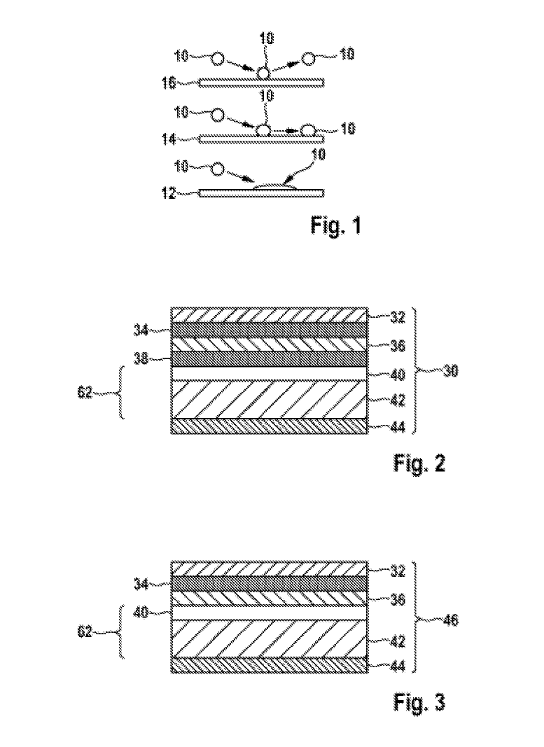

FIG. 1 schematically illustrates what is meant by the term superhydrophobic in the present context. It can be seen from the depiction in FIG. 1 that the measure of hydrophobicity, i.e. repulsion of polar materials, is determined by means of a contact angle. The more hydrophobic a surface or a surface substrate, the higher the contact angle. In the case of a hydrophilic layer 12 as per the depiction in FIG. 1, a water droplet 10 spreads out to form a spot, a pool or a puddle, characterized by a contact angle of <90°. Such a surface is described as hydrophilic. On the other hand, a hydrophobic layer 14 is characterized by a contact angle of >90°. It can be seen from the depiction in FIG. 1 that the water droplet 10 experiences only minimal deformation. Superhydrophobic materials, on the other hand, are characterized by a contact angle of >160°, i.e. the water droplet 10 remains virtually undeformed on contact with a superhydrophobic layer 16.

### EMBODIMENTS OF THE INVENTION

The depiction in FIG. 2 shows a first layer composite 30, which can also be referred to as first composite. In the first layer composite 30 as depicted in FIG. 2, it is possible to see, in descending order, firstly a first polymer layer 32 and adjoining first ceramic layer 34, finally a further, second polymer layer 36 and also a further, second ceramic layer 38. Between a lithium layer 42 and the second ceramic layer 38, there is a superhydrophobic, nanostructured protective layer 40 in the first layer composite 30 as depicted in FIG. 2. This protective layer 40 can, for example, be made of nanostructured polypropylene (PP), other polyolefins or polymers. Furthermore, it is possible to make the superhydrophobic, nanostructured protective layer 40 of nanostructured silicon, with nanostructured silicon having good lithium ion conduction properties. According to the depiction in FIG. 2, the superhydrophobic, nanostructured protective layer 40 has been applied directly to the lithium layer 42. In FIG. 2, a first electrode is denoted by the position 62. The lithium layer 42 covered by the superhydrophobic, nanostructured protective layer 40 represents the first electrode 62 which, in the first layer composite 30 as per the depiction in FIG. 2, is located above a power outlet lead 44 which is preferably made of copper. The further layers 32, 34, 36 and 38 depicted in the layer composite as per FIG. 2 serve to conduct lithium ions.

FIG. 3 shows a modification of the first layer composite, as is depicted in FIG. 2.

A second layer composite 46 depicted in FIG. 3 has, in contrast to the first layer composite 30 as shown in FIG. 2, only the first ceramic layer 34. Unlike the first layer composite 30 depicted in FIG. 2, the second ceramic layer 38 is absent in the second layer composite 46 as per FIG. 3. In the second layer composite 46 as depicted in FIG. 3, too, the first electrode 62 is formed by the lithium layer 42 and the superhydrophobic, nanostructured protective layer 40 which covers this. The second layer composite 46 as depicted in FIG. 3, too, comprises the power outlet lead 44 which is preferably made of copper.

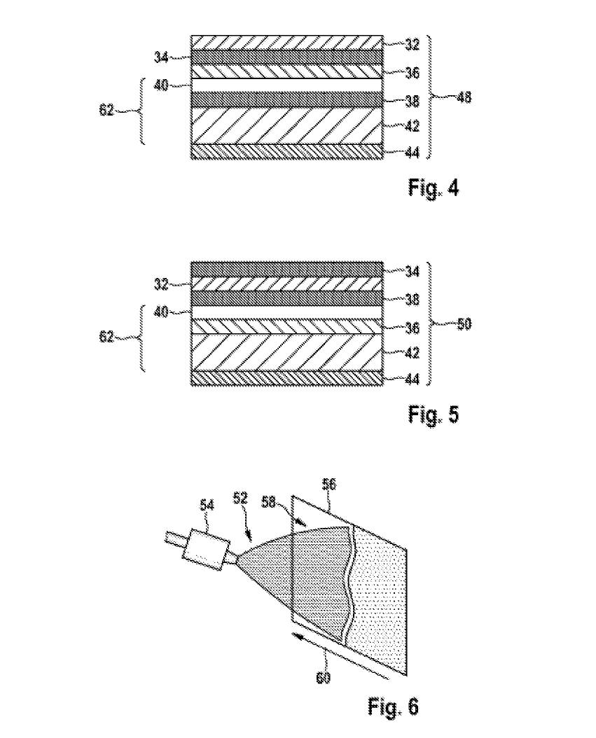

FIG. 4 finally shows a further, third variant of the layer of composite.

FIG. 4 shows a third layer composite 48 which corresponds in terms of the number of layers to the first layer composite 30 as depicted in FIG. 2, but has a different order in respect of the layer sequence. Unlike the first layer composite 30 as depicted in FIG. 2, a second ceramic layer 38 is present between the superhydrophobic, nanostructured protective layer 40 and the lithium layer 42 in the third layer 48 as depicted in FIG. 4. In this case, the first electrode is formed by the lithium layer 42, the superhydrophobic, nanostructured protective layer 40 and the second ceramic layer 38 accommodated between these. The sequence of the first polymer layer 32, the first ceramic layer 34 and the second polymer layer 36 is identical to the layer sequence within the first layer composite 30 as depicted in FIG. 2.

FIG. 5 shows a further, fourth possible embodiment of a layer composite 50 comprising a superhydrophobic, nanostructured protective layer 40. In the fourth layer composite 50 as depicted in FIG. 5, too, there is a further layer, in this case the polymer layer 36, between the superhydrophobic, nanostructured protective layer 40 and the lithium layer 42, in a manner comparable to the third layer of composite 48 as per FIG. 4. This means that the first electrode 62 within the fourth layer of composite 50 as per FIG. 5 is formed by the lithium layer 42, the second polymer layer 36 and the superhydrophobic, nanostructured protective layer 40. Above this, there is, in the reverse order compared to the third layer composite 48 as per FIG. 4, the first ceramic layer 34, the first polymer layer 32 and the second ceramic layer 38.

FIG. 6 schematically shows an application method for producing the superhydrophobic, nanostructured protective layer 40.

FIG. 6 shows that a spray mist 52 can be formed from a nanostructured polypropylene or from nanostructured silicon. The spray mist 52 is applied by means of a movable spray head 54 to a support substrate 56 which has a sufficient area 58. The spray head 54 can be moved relative to the support substrate 56 in the spray direction 60, so that in the case of uniform movement and application of the spray mist 52 to the support substrate 56, a thin film of the superhydrophobic, nanostructured protective layer 40 is produced. Application of the coating via the spray head 54 to the support substrate 56 is followed by drying, during which crosslinking or polymerization of the superhydrophobic, nanostructured protective layer 40 occurs.

Although not represented in drawing, the superhydrophobic, nanostructured protective layer 40 can also be produced by applying a thin layer by knife-coating, and by a subsequent drying operation. A further option is to produce the superhydrophobic, nanostructured protective layer 40 by evaporation or vacuum evaporation. The drying operation may then optionally be accompanied by crosslinking and/or polymerization.

If nanostructured silicon is selected as material of which the superhydrophobic, nanostructured protective layer 40 is made, use can be made of sputtering as application method. In addition, there is the possibility of applying nanostructured silicon by means of aerosol deposition to the support substrate 56. As an alternative to this method, there is the possibility of applying nanostructured silicon to the support substrate 56 by plasma enhanced chemical vapor deposition.

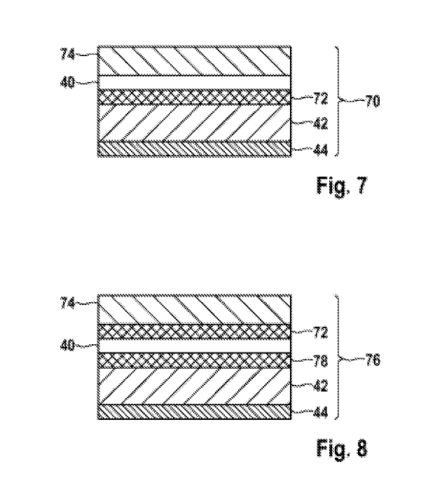

FIG. 7 depicts a further possible embodiment of a layer composite 70 having at least one superhydrophobic, nanostructured protective layer 40.

FIG. 7 shows the fifth layer of composite 70, i.e. a fifth composite which comprises the power outlet lead 44, the lithium layer 42 and a first separator layer 72, preferably a polymeric protective layer. In this illustrative embodiment, the superhydrophobic, nanostructured protective layer 40 is located between this first separator layer 72 and a second electrode 74. In the illustrated embodiment shown in FIG. 7, the superhydrophobic, nanostructured protective layer 40 has been applied directly to the second electrode 74 within the fifth layer of composite 70. The first separator layer 72 is located between the lithium layer 42 representing the first electrode 62. Instead of the first separator layer 72, it is also possible for a plurality of layers of ceramic layers or an alternating sequence of a plurality of polymer layers and ceramic layers to be arranged alternately within the fifth layer of composite 70 as depicted in FIG. 7.

FIG. 8 shows a further possible embodiment of a layer of composite 76 similar to the fifth layer of composite 70 depicted in FIG. 7.

FIG. 8 shows the sixth layer of composite 76, i.e. a sixth composite in which the superhydrophobic, nanostructured protective layer 40 is embedded between the first separator layer 72, preferably a polymer, and a second separator layer 78, likewise preferably a polymer. In this case, the superhydrophobic, nanostructured protective layer 40 is not arranged directly on the second electrode 74. The two separator layers 72, 78 are located between the lithium layer 42 representing the first electrode 62 and the second electrode 74. Furthermore, further layers, for example polymer layers and ceramic layers in an alternating sequence, can be located between the lithium layer 42 representing the first electrode 62 and the superhydrophobic, nanostructured protective layer 40.

The layer of composites 30, 46, 48, 50, 70 and 76 as per the above illustrative embodiments of FIGS. 2 to 5, 7 and 8 including at least one superhydrophobic, nanostructured protective layer 40 contributes significantly to increasing the life, the cycling stability and the safety of lithium batteries, in particular lithium-sulfur battery systems and lithium-oxygen battery systems. In addition, it is also possible to use such layer of composites 30, 46, 48, 50, 70 and 76 in the case of first electrode 62 composed of a lithium alloy. The use is also possible independently of the cathode chemistry or cathode structure.

In addition, the solution proposed according to the invention contributes to increasing the safety of lithium anodes in lithium batteries, since in the case of thermal stress, the reaction of liquid electrolyte with metallic lithium is prevented or at least significantly reduced.

The solution proposed according to the invention is used in lithium batteries for electric tools, garden tools, computers, notebooks, PDAs, smartphones and cell telephones. In particular, the solution proposed according to the invention can be used in traction batteries for hybrid vehicles, plug-in hybrid vehicles and in electric vehicles. Owing to the particularly demanding requirements in respect of service life in the automobile sector, the solution proposed according to the invention is of particular interest there.

The invention is not limited to the examples described here and the aspects emphasized therein. Rather, many modifications of the kind that a person skilled in the art would make as a matter of routine are possible within the scope of the claims.

1. A layer composite for an electrode of a rechargeable electrochemical element, the layer composite comprising:
at least one superhydrophobic, nanostructured protective layer configured to repel polar substances.

2. The layer composite as claimed in claim 1, wherein:
the superhydrophobic, nanostructured protective layer is made of nanostructured polypropylene, nanostructured polyethylene, nanostructured PE-PP copolymers or further polyolefins.

3. The layer composite as claimed in claim 1, wherein:
the superhydrophobic, nanostructured protective layer is made of nanostructured silicon or of a polymer.

4. The layer composite as claimed in claim 1, wherein:
the superhydrophobic, nanostructured protective layer within the layer composite is applied directly to a lithium layer or to a second electrode.

5. Layer composite as claimed in claim 1, wherein:
the superhydrophobic, nanostructured protective layer within the layer composite is covered by at least one second polymer layer and/or at least one second ceramic layer.

6. The layer composite as claimed in claim 1, wherein:
the superhydrophobic, nanostructured protective layer is applied to a lithium layer with immediate insertion of a second polymer layer and/or a second ceramic layer.

7. The layer composite as claimed in claim 1, further comprising:
at least one separator layer between a lithium layer and a second electrode.

8. A process for producing a layer composite, comprising:
applying a superhydrophobic, nanostructured protective layer to a support substrate,
wherein the superhydrophobic protective layer is produced by coating by:
a spray mist and subsequent drying with crosslinking or polymerization,
application using a doctor blade of a thin layer and subsequent drying, or
vapor deposition or vacuum vapor deposition and subsequent crosslinking or polymerization.

9. A process for producing a layer composite comprising:
applying a superhydrophobic, nanostructured protective layer of nanostructured silicon to a support substrate,
wherein the superhydrophobic, nanostructured protective layer is applied by sputtering, aerosol deposition or plasma enhanced chemical vapor deposition.

10. The layer composite as claimed in claim 1, wherein the layer composite is configured to be used in lithium batteries in traction batteries of hybrid vehicles, plug-in hybrid vehicles, electric vehicles or in electric tools, garden tools, computers, notebooks, PDAs, smartphones or cell telephones.
